(19) United States
(12) Patent Application Publication
(10) Pub. No.: US 2002/0157250 A1
(43) Pub. Date: Oct. 31, 2002

(54) Turbine blade and turbine

(76) Inventors: Michael Haendler, Erkrath (DE); Peter Tiemann, Witten (DE)

Correspondence Address: SIEMENS CORPORATION, INTELLECTUAL PROPERTY DEPT., 186 WOOD AVENUE SOUTH, ISELIN, NJ, 08830, US

(21) Appl. No.: 10/117,590

(22) Filed: Apr. 4, 2002

(30) Foreign Application Priority Data
Apr. 4, 2001 (EP) 01108477.9

(51) Int. Cl. B21K 3/04; B23P 15/02

(52) U.S. Cl. 29/889.7

(57) ABSTRACT

The present invention relates to a turbine blade, in particular for a gas turbine, having an airfoil profile and at least one platform for fastening to a primary component. According to the invention, each platform encloses an obtuse angle with a longitudinal axis of the airfoil profile. The design of the turbine blade as a single crystal is facilitated by this construction.

### CROSS-REFERENCE TO RELATED APPLICATIONS

This application claims priority to EP/01108477.9, filed Apr. 4, 2001 under the European Patent Convention and which is incorporated by reference herein in its entirety.

### FIELD OF THE INVENTION

The present invention relates to a turbine blade, in particular for a gas turbine, having an airfoil profile and at least one platform for fastening to a primary component. It also relates to a turbine using such a turbine blade.

### BACKGROUND OF THE INVENTION

Such turbine blades and casting methods for their production have been disclosed, for example, by U.S. Pat. No. 5,599,166 and U.S. Pat. No. 5,820,774. The platform provided in the known turbine blades projects in the circumferential direction of the turbine on both sides of the airfoil profile. It is perpendicular to a longitudinal axis of the airfoil profile.

Within the scope of increasing outputs and efficiency and of reducing the emission, the known turbine blades are no longer able to meet the thermal and mechanical boundary conditions. The aim is therefore to change the material structure to the effect that the turbine blade consists of a single, continuous crystal. In order to achieve the growth of such a single crystal, certain requirements must be fulfilled, such as, for example, a defined solidification temperature. A sudden change in the solidification cross section and/or in the solidification direction must be avoided as far as possible.

In the known turbine blades, the production of a single crystal turns out to be very difficult on account of the change in the solidification cross section and the solidification direction, in particular at the transition from the platform to the airfoil profile. The casting mold must be heated or cooled in places. Alternatively, or additionally, grain retainers must be provided. The effects of both possibilities can only be predicted with difficulty and are in addition subjected to fluctuations in the casting and solidifying process. The scrap rate therefore increases sharply.

An object of the present invention is therefore to provide a turbine blade which, on account of its special construction, can be designed as a single crystal in a simpler manner and with substantially less scrap than hitherto.

### SUMMARY OF THE INVENTION

According to the invention, this object is achieved in the case of a turbine blade of the type mentioned at the beginning in that each platform encloses an obtuse angle with a longitudinal axis of the airfoil profile.

The solidification direction therefore no longer has to be changed abruptly by 90 degrees as in the known blades. According to the invention, only a deflection by an angle which is less than 90 degrees is necessary. This again helps to design the turbine blade as a single crystal. It would of course be appropriate to then also design the turbine blade as a single crystal.

The at least one platform preferably projects in the circumferential direction.

Advantageous configurations and developments of the invention follow from the dependent claims.

Two platforms are advantageously provided, and these platforms are arranged at opposite ends of the airfoil profile. In this case, one of the platforms is designated as root plate and the other as tip plate. The first platform then serves for fastening to a casing or rotor of the turbine and for covering the intermediate space between two turbine blades. The ends of the airfoil profiles are connected to one another by means of the second platform.

The at least one platform is advantageously designed to be straight or partly or completely curved. A smooth or angled transition may be provided between the platforms of adjacent turbine blades. Optimum adaptation to the respective boundary conditions is thus achieved. The platforms may be curved only in a transition region to the airfoil profile and may otherwise be essentially straight. As uniform a cross section as possible with only low losses is made possible by this configuration.

According to a first advantageous configuration, the platforms project on both sides of the airfoil profile. They can be arranged symmetrically to the longitudinal axis of the airfoil profile. The longitudinal axis, as in the known constructions, can then pass through a rotation axis of a rotor of the turbine.

According to a second advantageous configuration, the at least one platform projects only on one side of the airfoil profile. A repeated change in the solidification direction is avoided by the projection of the platform only on one side. The solidification may start at a free end of the airfoil profile and then continue up to the end of the platform. Alternatively, the solidification may start at a free end of the platform and then proceed across the airfoil profile right up to the free end of a second platform possibly provided. If only one platform is used, only one change in the solidification direction therefore occurs. This configuration thus also permits a simpler design of the turbine blade as a single crystal.

In this configuration, if two platforms at opposite ends of the airfoil profile are used, these platforms can project on different sides, in particular opposite one another, of the airfoil profile. In the circumferential direction, for example, the root plate then projects to the left and the tip plate projects to the right. This construction reduces undercuts and thus simplifies the production. The intended design of the turbine blade as a single crystal is advantageously assisted by the projection on different sides, since a reversal of the solidification direction is not necessary.

The turbine blade according to the invention may be designed in particular as a guide blade. The use of guide blades in the form of a single crystal permits a reduction in the wall thickness of the guide blades. This reduction enables the consumption of a cooling medium used for cooling to be reduced.

The invention also relates to a turbine, in particular a gas turbine, having a casing and a rotor accommodated in the casing and also a plurality of the above-described turbine blades according to the second configuration. According to the invention, a longitudinal axis of the airfoil profile of each turbine blade runs at a distance from a rotation axis of the rotor. The turbine blades are thus no longer arranged parallel to the radius of the turbine. On the contrary, the longitudinal axis of the airfoil profile of each turbine blade encloses an angle of advantageously between 8 and 18 degrees with a radius of the turbine. The size of the angle depends on the extent of the inclination of the at least one platform relative to the longitudinal axis of the airfoil profile.

Other objects and advantages of this invention will become apparent from the following description taken in conjunction with the accompanying drawings wherein are set forth, by way of illustration and example, certain embodiments of this invention. The drawings constitute part of this specification and include exemplary embodiments of the present invention and illustrate various objects and features thereof.

### BRIEF DESCRIPTION OF THE DRAWING

The invention is explained in more detail below with reference to exemplary embodiments which are shown in a schematic manner in the drawing, in which:

FIG. 1 shows a schematic longitudinal section through a turbine;

FIG. 2 shows a section along line II-II in FIG. 1 in a turbine according to the prior art;

FIG. 3 shows a representation of an individual turbine blade according to the prior art;

FIG. 4 shows a schematic representation of the solidification direction in a turbine blade according to the prior art;

FIGS. 5 to 7 show views corresponding to FIGS. 2 to 4 in the case of a turbine blade according to the invention;

FIGS. 8 to 10 show further exemplary embodiments of the invention in a view similar to FIG. 5; and

FIG. 11 shows a view of a turbine blade according to arrow direction XI in FIG. 10.

The same parts are provided with the same reference numerals in all the figures.

### DETAILED DESCRIPTION OF THE INVENTION

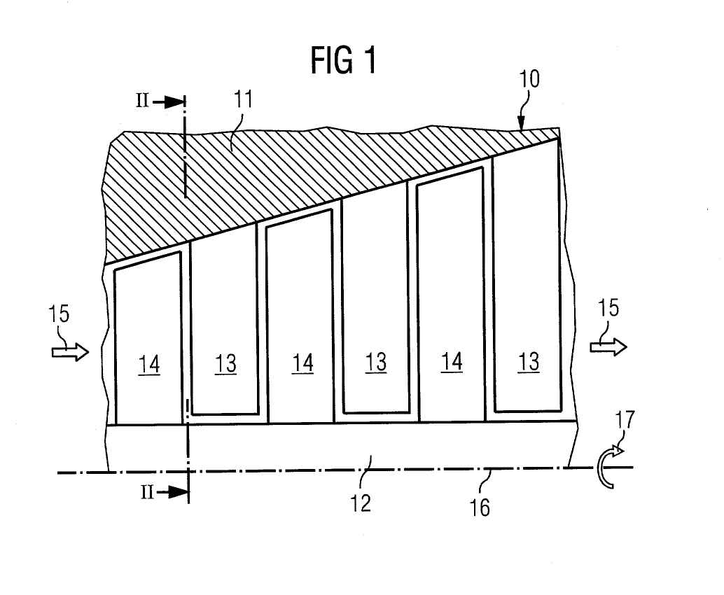

FIG. 1 shows a schematic longitudinal section through a gas turbine 10 having a casing 11 and a rotor 12. The casing 11 is provided with guide blades 13 and the rotor 12 is provided with moving blades 14. Hot gas flows through the gas turbine 10 in arrow direction 15 and leads to rotation of the rotor 12 about its rotation axis 16 in arrow direction 17.

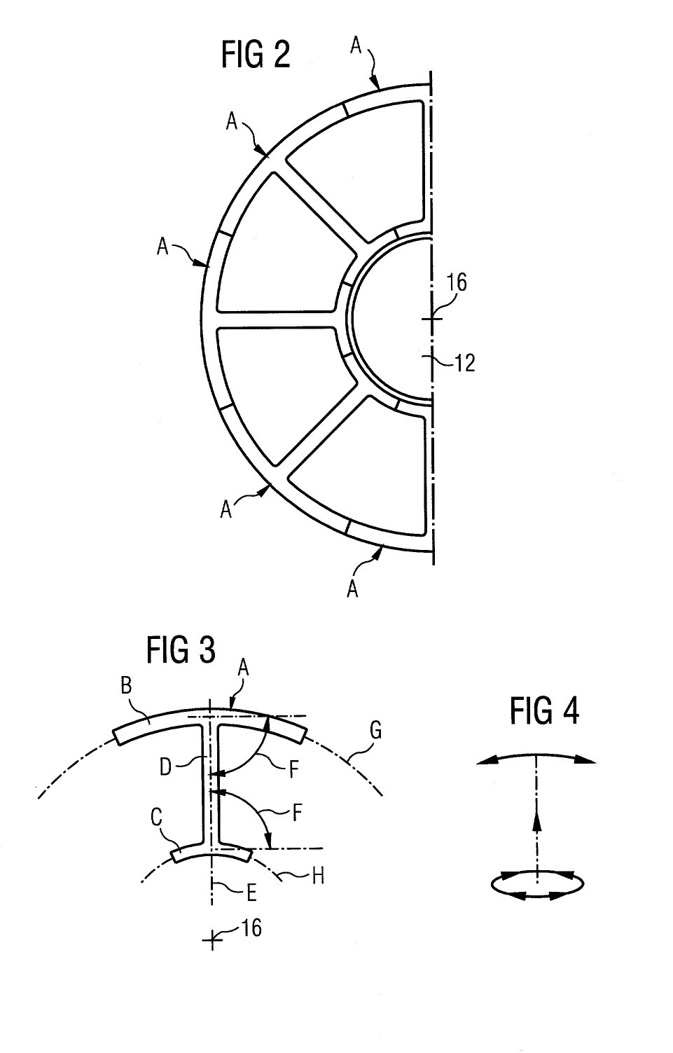

FIGS. 2 to 4 show a configuration according to the prior art. As can be seen in particular from FIGS. 2 and 3, a plurality of guide blades A are provided, these guide blades A being distributed uniformly over the circumference of the gas turbine 10. Each guide blade A has a root plate B for fastening to the casing 11 and for covering the distance between two guide blades A, a tip plate C, and an airfoil profile D in between. A longitudinal axis E of the airfoil profile passes through the rotation axis 16 of the rotor 12. The root and tip plates B, C each project from the airfoil profile D at a right angle F. For clarification, the circles formed by the root plates B and tip plates C are indicated schematically by dot-dash lines G, H.

The solidification direction during the casting of the known guide blade A is shown schematically in FIG. 4. Starting from that end of the guide blade A which faces the rotor 12, first of all the tip plate C has to solidify. In the process, the solidification direction changes by 180 degrees. The solidification direction then changes again by 90 degrees when the airfoil profile D is being formed. At the transition to the tip plate B, the solidification must split up in the circumferential direction to the left and right while enclosing a right angle. A design of the known guide blade A as a single crystal can therefore only be achieved by expensive measures. Even then, there is a very high scrap rate.

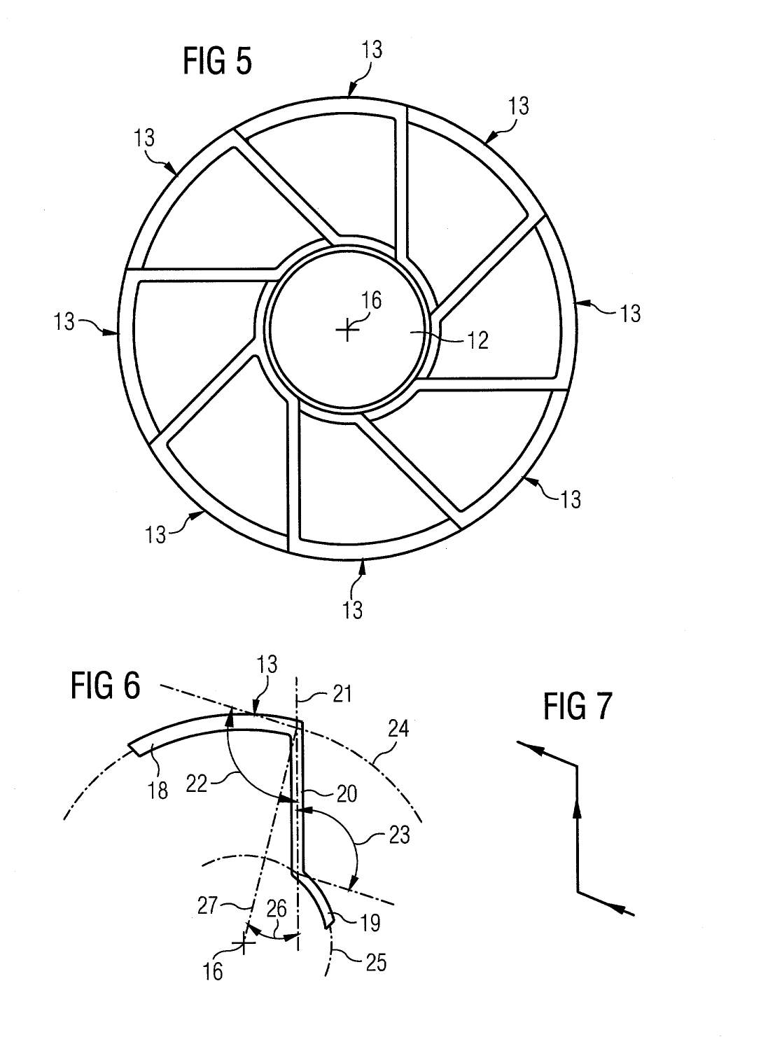

A guide blade 13 according to the invention and a turbine design according to the invention are shown in more detail in FIGS. 5 to 7. As in the prior art, a plurality of guide blades 13 distributed uniformly over the circumference of the gas turbine 10 are provided. Each guide blade 13 has a root plate 18, a tip plate 19 and an airfoil profile 20 in between having a longitudinal axis 21. The longitudinal axis 21 runs at a distance from the rotation axis 16 of the rotor 12. It encloses an angle 26 with a radius 27, this angle 26 being about 8 degrees in the exemplary embodiment shown.

Both the root plate 18 and the tip plate 19 project in the circumferential direction only on one side of the airfoil profile 20. In this case, in the representation according to FIG. 6, the root plate 18 projects to the left and the tip plate 19 projects on the opposite side, that is to the right. Both plates 18, 19 each enclose an obtuse angle 22, 23 with the longitudinal axis 21 of the airfoil profile 20. The circles formed by the root plates 18 and the tip plates 19 are again represented schematically by dot-dash lines 24, 25.

Both the root plate 18 and the tip plate 19 extend directly up to the airfoil profile 20 of the respectively adjacent guide blade 13. Their free ends are appropriately adapted in terms of the shape. They may be directly anchored on the adjacent airfoil profile 20. Alternatively, the plates 18, 19 may be designed to be deformable to a certain extent. The maximum permissible deformation is limited by a suitable stop (not shown in any more detail).

In the exemplary embodiment shown, the root plate 18 is arranged on the suction side of the airfoil profile 20 and the tip plate 19 is arranged on the pressure side.

The solidification direction of the guide blade 13 according to the invention is shown schematically in FIG. 7. On account of the blade design according to the invention, abrupt, right-angled changes in the solidification direction no longer occur. Likewise, no splitting of the solidification direction as in the known blades is required. The guide blade 13 according to the invention can therefore be designed as a single crystal in a simple and cost-effective manner with substantially reduced scrap rates. It can then be loaded to a markedly greater extent than the known blades both thermally and mechanically.

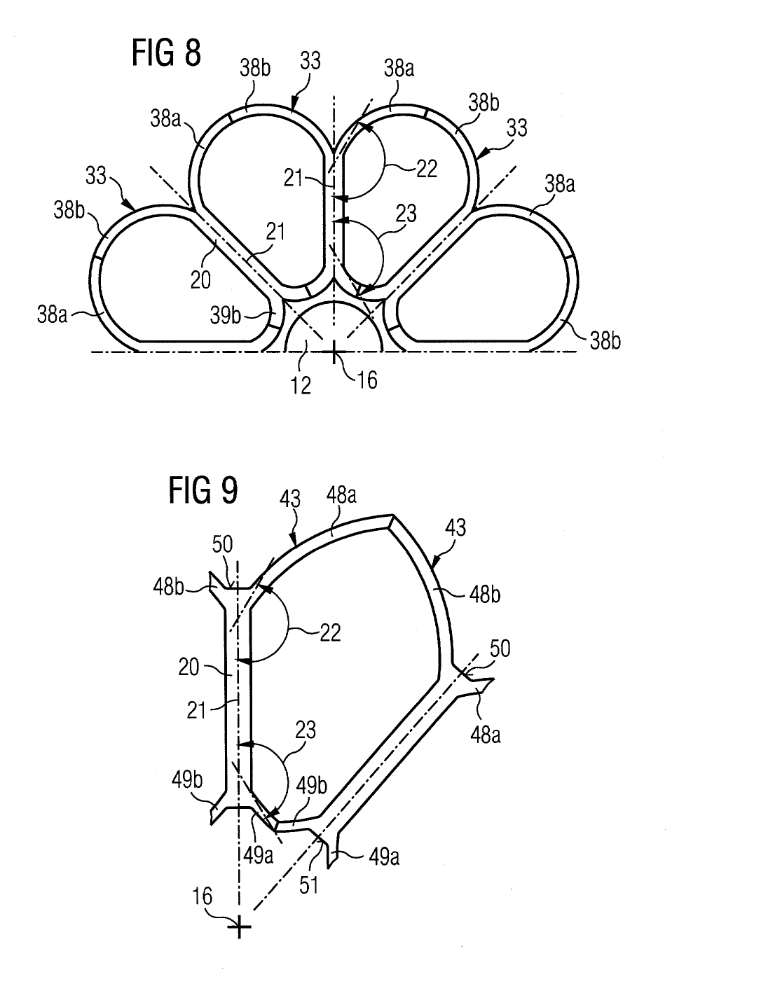

FIGS. 8 and 9 show two further exemplary embodiments of the invention in a view similar to FIG. 5. Shown in FIG. 8 are guide blades 33 which in each case have a root platform 38a, 38b and a tip platform 39a, 39b. Both platforms 38a, 38b, 39a, 39b project on both sides of the airfoil profile 20 and are arranged symmetrically to the longitudinal axis 21. The platforms 38a, 38b, 39a, 39b are of curved design. In this case, the abutting sections 38a, 38b merge smoothly into one another. They each enclose an obtuse angle 22, 23 with the longitudinal axis 21.

On account of the curved configuration of the platforms 38a, 38b, 39a, 39b, projection at an obtuse angle 22, 23 can be achieved, although all the longitudinal axes 21 intersect the rotation axis 16 of the rotor 12.

FIG. 9 shows a further configuration. In these guide blades 43, platforms 48a, 48b, 49a, 49b which are also curved are provided. In each case straight transition regions 50, 51 are arranged between the sections 48a, 48b, 49a, 49b of a guide blade 43. The individual sections 48a, 49a again enclose in each case an obtuse angle 22, 23 with the longitudinal axis 21. On account of the symmetrical arrangement as in FIG. 8, the same angles 22, 23 are obtained for sections 48b, 49b. As in FIG. 8, the longitudinal axes 21 intersect the rotation axis 16.

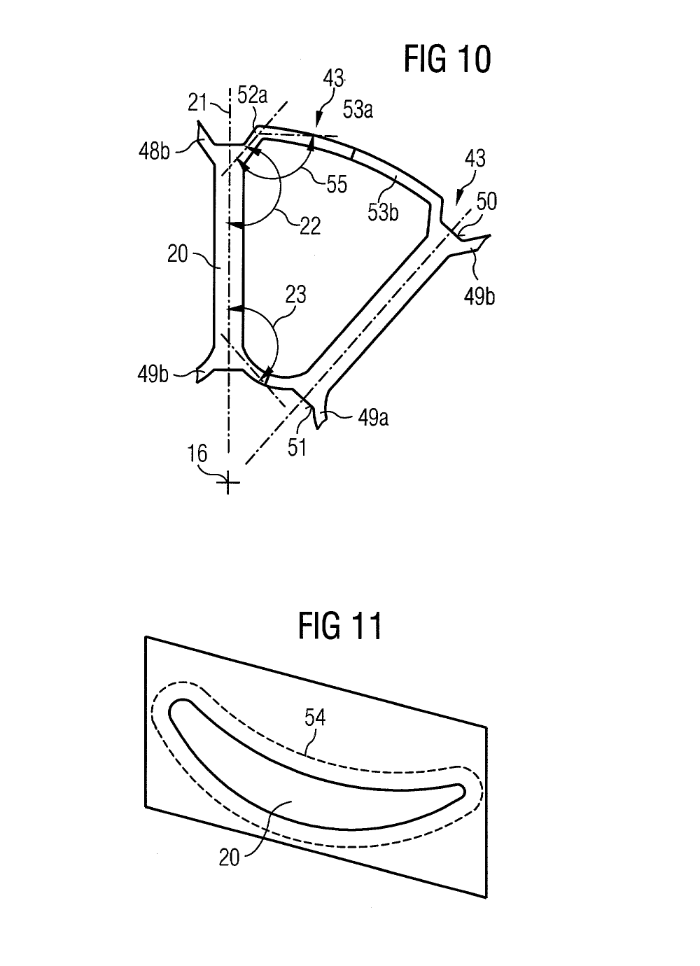

A third configuration of a guide blade 43 is shown in FIGS. 10 and 11. The platforms 48a, 48b, 49a, 49b have a first, curved region 52a, 52b and a further, essentially straight region 53a, 53b. The transition between the regions 52a, 53a and 52b, 53b, respectively, is schematically indicated in FIG. 11 by the broken line 54.

The curvature of the region 53a, 53b is smaller than that of the region 52a, 52b. It is advantageously selected in such a way that the region 53a, 53b defines a cylindrical section about the rotation axis 16. During operation of the turbine 10, therefore, only minimum gaps form between the free ends of the moving blades 14 and the region 53a, 53b. Flow losses past the moving blades 14 can therefore be reduced to a minimum.

In this case, the length of the region 52a, 52b is selected in such a way that the solidification front can emerge from the airfoil profile 20 and be deflected in the direction of the region 52a, 52b. This is followed by another change of direction in the direction of the region 53a, 53b. The angle 55 of the deflection, like the angles 22, 23, is greater than 90 degrees. This change in the solidification direction can therefore be controlled effectively. The cross section of the regions 52a, 52b, 53a, 53b is approximately the same, so that only one change in the solidification direction is necessary.

The present invention avoids a sudden directional and cross-sectional change in the solidification direction during the production of the guide blades 13, 33, 43. The guide blades 13, 33, 43 can therefore by designed as a single crystal in a substantially simpler manner than hitherto.

It is to be understood that while certain forms of the invention have been illustrated and described, it is not to be limited to the specific forms or arrangement of parts herein described and shown. It will be apparent to those skilled in the art that various, including modifications, rearrangements and substitutions, may be made without departing from the scope of this invention and the invention is not to be considered limited to what is shown in the drawings and described in the specification. The scope if the invention is defined by the claims appended hereto.

What is claimed is:

1. A turbine blade for a gas turbine comprising:
an airfoil profile portion;
at least one platform extending from said airfoil profile portion, said platform being adapted for fastening to a primary component;
wherein said at least one platform forms an obtuse angle with a longitudinal axis of the airfoil profile portion.

2. The turbine blade as claimed in claim 1, wherein two platforms are provided, and said platforms are arranged at opposite ends of the airfoil profile portion.

3. The turbine blade as claimed in claim 1, wherein said at least one platform includes a curved region.

4. The turbine blade as claimed in claim 2, wherein said platforms project from opposite sides of the airfoil profile portion.

5. The turbine blade as claimed in claim 4, wherein said platforms are arranged symmetrically to the longitudinal axis of the airfoil profile portion.

6. The turbine blade as claimed in claim 2, wherein said platforms extend from one side of the airfoil profile portion.

7. The turbine blade as claimed in claim 2, wherein said platforms project from different sides of the airfoil profile portion, said platforms being opposite one another.

8. The turbine blade as claimed in claim 1, wherein said turbine blade is a single crystal.

9. The turbine blade as claimed in claim 1, wherein said turbine blade is designed as a guide blade.

10. In combination with a gas turbine having a casing and a rotor accommodated in the casing, a plurality of turbine blades as claimed in claim 6, wherein a longitudinal axis of the airfoil profile portion of each of said turbine blades is spaced a predetermined distance from a rotation axis of the rotor.

11. The combination claimed in claim 10, wherein the longitudinal axis of the airfoil profile portion of each turbine blade forms an angle of between about 8° to about 18° with a radius of the gas turbine.

12. In combination with a gas turbine having a casing and a rotor accommodated in the casing, a plurality of turbine blades as claimed in claim 7, wherein a longitudinal axis of the airfoil profile portion of each of said turbine blades is spaced a predetermined distance from a rotation axis of the rotor.

13. The combination claimed in claim 12, wherein the longitudinal axis of the airfoil profile portion of each turbine blade forms an angle of between about 8° to about 18° with a radius of the gas turbine.

14. A single crystal turbine blade for a gas turbine comprising:
an airfoil profile portion;
at least one platform extending from said airfoil profile portion, said platform being adapted for fastening to a primary component;
wherein said at least one platform forms an obtuse angle with a longitudinal axis of the airfoil profile portion.

15. The turbine blade as claimed in claim 14, wherein:
two platforms are provided, and said platforms are arranged at opposite ends of the airfoil profile portion.

16. The turbine blade as claimed in claim 14, wherein:
said at least one platform includes a curved region.

17. The turbine blade as claimed in claim 15, wherein:
said platforms project from opposite sides of the airfoil profile portion.

18. The turbine blade as claimed in claim 17, wherein said platforms are arranged symmetrically to the longitudinal axis of the airfoil profile portion.

19. The turbine blade as claimed in claim 15, wherein said platforms extend from one side of the airfoil profile portion.

20. The turbine blade as claimed in claim 15, wherein said platforms project from different sides of the airfoil profile portion, said platforms being opposite one another.
